(19) United States
(12) Patent Application Publication
(10) Pub. No.: US 2024/0317082 A1
(43) Pub. Date: Sep. 26, 2024

(54) CONTACTLESS ELECTRIC POWER TRANSMISSION SYSTEM

(71) Applicant: HONDA MOTOR CO., LTD., Tokyo (JP)

(72) Inventor: Jin Katsuya, Wako-shi (JP)

(21) Appl. No.: 18/582,700

(22) Filed: Feb. 21, 2024

(30) Foreign Application Priority Data
Mar. 22, 2023 (JP) 2023-045638

(51) Int. Cl. B60L 53/126; B60L 58/32

(52) U.S. Cl. CPC B60L 53/126; B60L 58/32

(57) ABSTRACT

A contactless electric power transmission system includes an electric power reception device, a control device, a first temperature sensor, and a second temperature sensor. The electric power reception device includes a housing, a secondary side coil, a core member, and a substrate on which an element is mounted. The first temperature sensor detects a temperature of external air in contact with a surface of the housing. The second temperature sensor detects a temperature of the substrate. The control device estimates at least a temperature of the secondary side coil based on a thermal model of a coil unit and a detection value of the temperature output from each temperature sensor and controls electric power received from an electric power transmission device in response to the temperature of the secondary side coil.

### CROSS-REFERENCE TO RELATED APPLICATION

Priority is claimed on Japanese Patent Application No. 2023-045638, filed on Mar. 22, 2023, the contents of which are incorporated herein by reference.

### BACKGROUND

### Field of the Invention

The present invention relates to a contactless electric power transmission system.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a contactless electric power transmission system that supplies electric power to a vehicle from the outside of the vehicle by contactless electric power transmission, a system is known which estimates a temperature around an electric power reception coil on the basis of a loss electric power of an electric power transmission coil and a heat generation amount of an electric power reception device (for example, refer to PCT International Publication No. WO 2016/162940).

### SUMMARY

In techniques relating to charging and electric power supply in a vehicle on which a secondary battery is mounted, it is desired to prevent a weight increase and complication of a device configuration, for example, by ensuring a cooling requirement amount by air cooling using wind (travel wind) received at the time of traveling of the vehicle or the like without the need to include an additional cooling device such as a liquid cooling device for cooling an electric power reception device. For example, in the contactless electric power transmission system of the related art described above, it is desired to accurately perform an output control for reducing the cooling requirement amount by accurately estimating not only an ambient temperature of an electric power reception coil but also a temperature of a plurality of locations in a heat transfer path of the electric power reception device.

An aspect of the present invention aims to provide a contactless electric power transmission system capable of improving the accuracy of temperature estimation at an electric power reception side and accurately performing an output control. Further, the aspect of the present invention contributes to energy efficiency.

A contactless electric power transmission system according to a first aspect of the present invention includes: a coil unit which includes a housing having a surface that is exposed to an outside, a coil that is arranged within the housing and receives AC electric power transmitted in a contactless manner from an electric power transmission device, a magnetic member provided for the coil within the housing, and a substrate on which an electronic component is mounted within the housing; a first temperature sensor that detects a temperature of external air in contact with the surface of the housing; a second temperature sensor that detects a temperature of the substrate; and a control device that estimates at least a temperature of the coil based on a thermal model of the coil unit and a detection value of the temperature output from each of the first temperature sensor and the second temperature sensor and controls a request frequency of electric power transmission by the electric power transmission device and electric power which the coil receives from the electric power transmission device in response to the temperature of the coil.

A second aspect is the contactless electric power transmission system according to the first aspect described above, wherein in the thermal model, the control device may connect the external air and the housing directly and via a heat release member, the electronic component, and the substrate sequentially and connect the housing and the coil via the magnetic member.

According to the first aspect described above, by estimating at least the temperature of the coil by using the thermal model of the heat transfer path on the electric power reception side, the control device can reliably perform an output control in the case of air cooling. The increase of the cooling requirement amount is prevented by the output control in accordance with the temperature of the coil, and it is possible to ensure a desired cooling requirement amount by air cooling, for example, without the need to include an additional cooling device such as a liquid cooling device.

In the case of the second aspect described above, the temperature of the coil can be accurately estimated by the thermal model in consideration of heat generation of electronic component within the housing in addition to heat generation of the coil and the magnetic member within the housing.

### BRIEF DESCRIPTION OF THE DRAWINGS

FIG. 1 is a view showing a configuration of a contactless electric power transmission system of an embodiment of the present invention.

FIG. 2 is a view showing details of the configuration of the contactless electric power transmission system of the embodiment of the present invention.

FIG. 3 is a view showing a configuration of an electric power transmission portion and an electric power reception portion in the contactless electric power transmission system of the embodiment of the present invention.

FIG. 4 is a cross-sectional view showing a configuration of a coil unit of an electric power reception device in the contactless electric power transmission system of the embodiment of the present invention.

FIG. 5 is a view showing an example of a thermal model of the coil unit in the contactless electric power transmission system of the embodiment of the present invention.

### DESCRIPTION OF EMBODIMENTS

Hereinafter, a contactless electric power transmission system according to an embodiment of the present invention will be described with reference to the drawings.

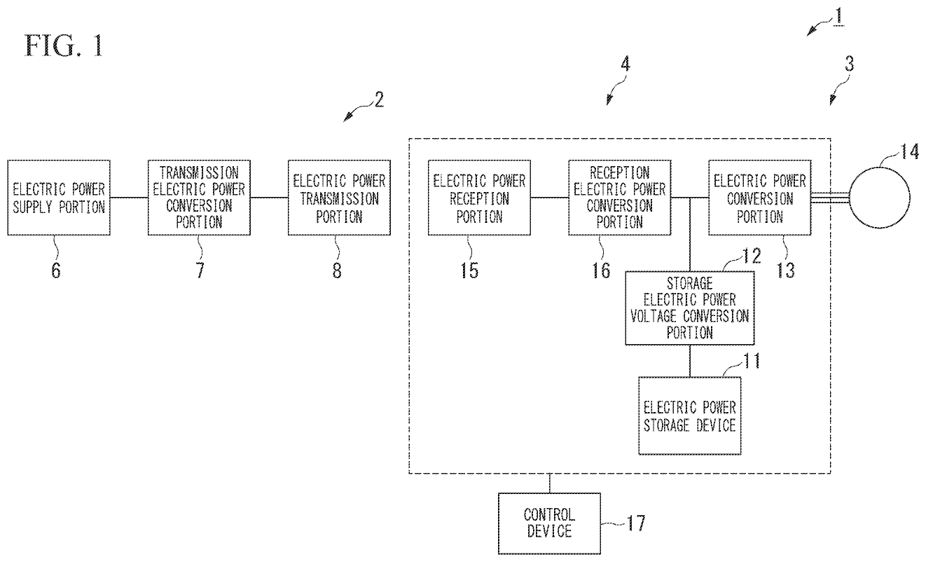

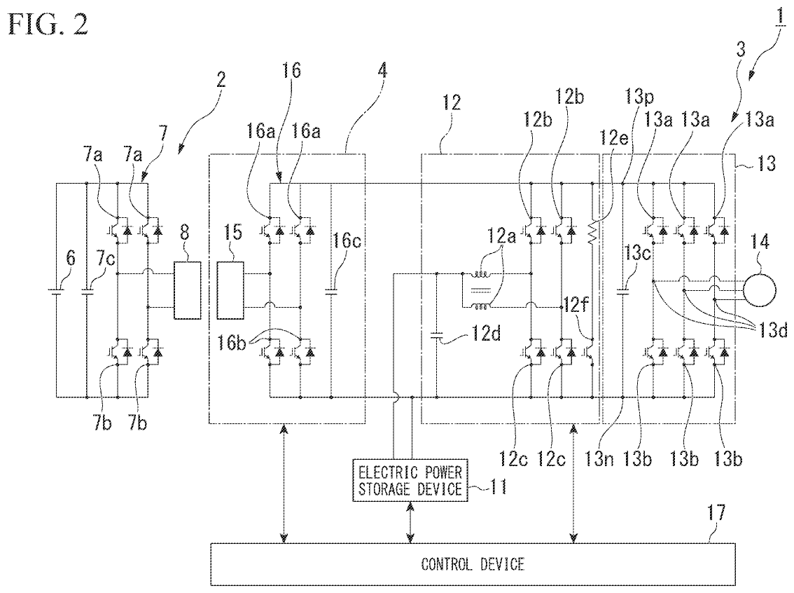

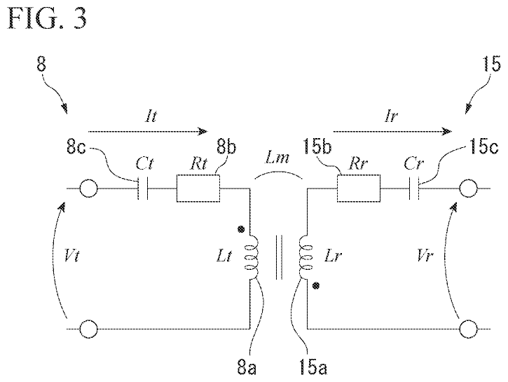

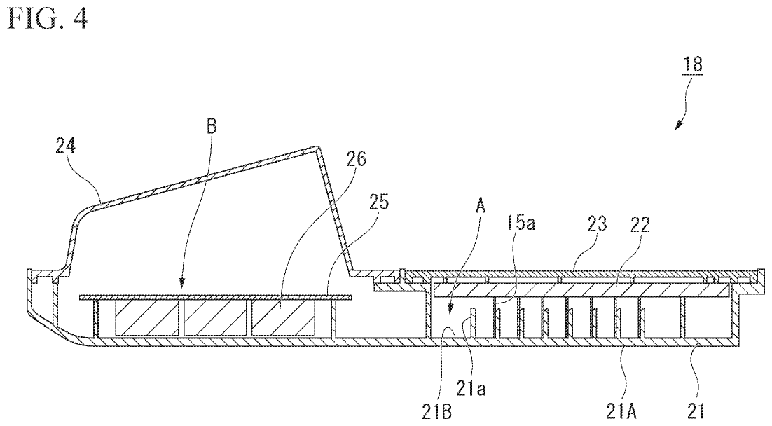

FIG. 1 and FIG. 2 are views showing a configuration of a contactless electric power transmission system 1 of an embodiment. FIG. 3 is a view showing a configuration of an electric power transmission portion 8 and an electric power reception portion 15 of the contactless electric power transmission system 1 in the embodiment. FIG. 4 is a cross-sectional view showing a configuration of a coil unit 18 of an electric power reception device 4 in the contactless electric power transmission system 1 of the embodiment.

For example, the contactless electric power transmission system 1 of the embodiment supplies electric power from the outside of a movable body such as a vehicle to the movable body by contactless electric power transmission. Examples of the vehicle include electric vehicles such as electric automobiles, hybrid vehicles, plug-in hybrid vehicles, and fuel cell vehicles.

### (Contactless Electric Power Transmission System)

As shown in FIG. 1 and FIG. 2, the contactless electric power transmission system 1 of the embodiment includes, for example: an electric power transmission device 2 provided on a travel path or the like of a vehicle; and a drive control device 3 and the electric power reception device 4 that are mounted on a movable body such as a vehicle. The contactless electric power transmission system 1 of the embodiment may include at least configuration elements (for example, the drive control device 3 and the electric power reception device 4) mounted on the movable body, and the contactless electric power transmission may be performed by the combination of a configuration element (for example, the electric power transmission device 2) at the outside of the movable body and the contactless electric power transmission system 1 mounted on the movable body.

The electric power transmission device 2 includes, for example, an electric power supply portion 6, a transmission electric power conversion portion 7, and the electric power transmission portion 8. The electric power transmission device 2 may include, for example, at least a plurality of the electric power transmission portions 8 in a predetermined electric power transmission zone on the travel path or the like of the vehicle.

The electric power supply portion 6 includes, for example, an AC electric power supply such as a commercial electric power supply, an AC-DC converter that converts AC electric power into DC electric power, and an electric power-smoothing capacitor. The electric power supply portion 6 converts AC electric power supplied from the AC electric power supply into DC electric power by the AC-DC converter.

The transmission electric power conversion portion 7 includes, for example, an inverter that converts DC electric power into AC electric power. For example, the inverter of the transmission electric power conversion portion 7 includes: a bridge circuit formed of a plurality of switching elements connected in two phases by bridge connection and a rectifier element; and a voltage-smoothing capacitor 7c. Each switching element is, for example, a transistor such as a SiC (Silicon Carbide) MOSFET (Metal-Oxide-Semiconductor Field-Effect Transistor). The plurality of switching elements are high-side arm and low-side arm transistors 7a, 7b that form a pair in each phase. The rectifier element is, for example, a reflux diode connected in parallel to each transistor 7a, 7b. The voltage-smoothing capacitor 7c is connected in parallel to the bridge circuit.

The electric power transmission portion 8 transmits electric power by a change of a high-frequency magnetic field, for example, by magnetic field coupling such as magnetic field resonance or electromagnetic induction. As shown in FIG. 3, the electric power transmission portion 8 includes a resonance circuit formed of, for example, a primary side coil 8a, a primary side resistance 8b, and a primary side capacitor 8c that are connected in series. The electric power transmission portion 8 includes, for example, a sensor such as a current sensor that detects a current It flowing through the resonance circuit.

For example, the electric power transmission device 2 performs electric power transmission to the electric power reception device 4 of the vehicle by controlling the switching between ON (conduction) and OFF (cutoff) of each switching element of the transmission electric power conversion portion 7 in response to information of a drive frequency set in advance or a request frequency received from the electric power reception device 4.

As shown in FIG. 1 and FIG. 2, the drive control device 3 of the movable body such as a vehicle includes, for example, an electric power storage device 11, a storage electric power voltage conversion portion 12, an electric power conversion portion 13, and a rotary electric machine 14. The electric power reception device 4 of the movable body includes, for example, the electric power reception portion 15 and a reception electric power conversion portion 16. The drive control device 3 and the electric power reception device 4 include, for example, a common control device 17.

For example, in the case of an electric automobile or the like that is driven using the electric power storage device 11 as a power source, the drive control device 3 may not include the storage electric power voltage conversion portion 12. For example, in the case of a hybrid vehicle or the like that is driven using the electric power storage device 11 and an internal combustion engine as a power source, the drive control device 3 may include the storage electric power voltage conversion portion 12.

The electric power storage device 11 is connected to the storage electric power voltage conversion portion 12. The electric power storage device 11 is charged by electric power transmitted in a contactless manner from the electric power transmission device 2 at the outside of the vehicle. The electric power storage device 11 performs transmission and reception of electric power with the rotary electric machine 14 via the storage electric power voltage conversion portion 12 and the electric power conversion portion 13.

The electric power storage device 11 includes, for example, a battery such as a lithium-ion battery, a current sensor that detects a current of the battery, and a voltage sensor that detects a voltage of the battery.

For example, in an electric automobile or the like, when the storage electric power voltage conversion portion 12 is not provided, the electric power storage device 11 is connected to the electric power conversion portion 13 and the reception electric power conversion portion 16 described later.

The storage electric power voltage conversion portion 12 is connected to the electric power conversion portion 13 and the reception electric power conversion portion 16. The storage electric power voltage conversion portion 12 includes, for example, a voltage controller that performs a bi-directional voltage conversion of increasing the voltage and decreasing the voltage.

The voltage controller converts input electric power and output electric power at the time of charging and discharging of the electric power storage device 11 by the bi-directional voltage conversion. The voltage controller of the storage electric power voltage conversion portion 12 includes, for example, a pair of first reactors, a first element module, and a voltage-smoothing capacitor 12d.

A pair of first reactors 12a, 12a form a composite reactor by being magnetically coupled to each other at opposite polarity. The pair of first reactors 12a, 12a are connected to a connection point between a high-side arm and a low-side arm of each phase of the first element module.

The first element module includes a first bridge circuit formed of, for example, a plurality of switching elements connected in two phases by bridge connection and a rectifier element. Each switching element is, for example, a transistor such as a SiC MOSFET. The plurality of switching elements are high-side arm and low-side arm transistors 12b, 12c that form a pair in each phase. The rectifier element is, for example, a reflux diode connected in parallel to each transistor 12b, 12c. The voltage-smoothing capacitor 12d is connected in parallel to the electric power storage device 11.

The storage electric power voltage conversion portion 12 includes a resistance 12e and a transistor 12f that are connected in series. The resistance 12e and the transistor 12f are connected in parallel to the first bridge circuit.

The pair of first reactors 12a, 12a and the first element module of the voltage controller perform voltage conversion by so-called two-phase interleaving. In the two-phase interleaving, one cycle of a switching control of a first-phase transistor 12b, 12c of two-phase transistors 12b, 12c connected to the pair of first reactors 12a, 12a and one cycle of a switching control of a second-phase transistor 12b, 12c are displaced from each other by half a cycle.

The electric power conversion portion 13 is connected to the rotary electric machine 14. The electric power conversion portion 13 includes, for example, an electric power converter that performs conversion between DC electric power and AC electric power. The electric power converter includes, for example, a second element module and a voltage-smoothing capacitor 13c.

The second element module includes a second bridge circuit formed of, for example, a plurality of switching elements connected in three phases by bridge connection and a rectifier element. Each switching element is, for example, a transistor such as a SiC MOSFET. The plurality of switching elements are high-side arm and low-side arm transistors 13a, 13b that form a pair in each phase.

The rectifier element is, for example, a reflux diode connected in parallel to each transistor 13a, 13b. The voltage-smoothing capacitor 13c is connected in parallel to the second bridge circuit.

The second element module controls an operation of the rotary electric machine 14 by transmission and reception of electric power. For example, at the time of power running of the rotary electric machine 14, the second element module converts DC electric power input from DC terminals 13p, 13n of a positive electrode and a negative electrode into three-phase AC electric power and supplies the three-phase AC electric power from a three-phase AC terminal 13d to the rotary electric machine 14. The second element module generates a rotation drive force by sequentially commutating electric power supply to a three-phase stator winding of the rotary electric machine 14.

For example, at the time of regeneration of the rotary electric machine 14, the second element module converts the three-phase AC electric power input from the three-phase stator winding into DC electric power by the driving between ON (conduction) and OFF (cutoff) of the switching element of each phase synchronized with the rotation of the rotary electric machine 14. The second element module is capable of supplying the DC electric power converted from the three-phase AC electric power to the electric power storage device 11 via the storage electric power voltage conversion portion 12.

The rotary electric machine 14 is, for example, a three-phase AC brushless DC motor provided for traveling and driving of the vehicle. The rotary electric machine 14 includes a rotor having a field permanent magnet and a stator having a three-phase stator winding that generates a rotation magnetic field which rotates the rotor. The three-phase stator winding is connected to the three-phase AC terminal 13d of the electric power conversion portion 13.

The rotary electric machine 14 generates a rotation drive force by performing a power running operation using electric power supplied from the electric power conversion portion 13. For example, when the rotary electric machine 14 is connectable to a wheel of the vehicle, the rotary electric machine 14 generates a travel drive force by performing the power running operation using electric power supplied from the electric power conversion portion 13. The rotary electric machine 14 may generate electric power by performing a regeneration operation using a rotation power input from the wheel side of the vehicle. When the rotary electric machine 14 is connectable to the internal combustion engine of the vehicle, the rotary electric machine 14 may generate electric power using the power of the internal combustion engine.

The electric power reception portion 15 is connected to the reception electric power conversion portion 16. The electric power reception portion 15 receives electric power by a change of a high-frequency magnetic field transmitted from the electric power transmission portion 8, for example, by magnetic field coupling such as magnetic field resonance or electromagnetic induction. As shown in FIG. 3, the electric power reception portion 15 includes a resonance circuit formed of, for example, a secondary side coil 15a (coil), a secondary side resistance 15b, and a secondary side capacitor 15c that are connected in series. The electric power reception portion 15 includes, for example, a sensor such as a current sensor that detects a current Ir flowing through the resonance circuit.

As shown in FIG. 4, the coil unit 18 that constitutes part of the electric power reception device 4 includes, for example, the secondary side coil 15a, a housing 21, a core member 22 (magnetic member), a back member 23, a cover member 24, a substrate 25, and an element 26 (electronic component).

An outer shape of the secondary side coil 15a is formed, for example, in a spiral form around a center axis line.

The housing 21 includes, for example, a plurality of heat release members 21a that protrude to the inside from an inner surface 21B on the rear side with respect to a surface 21A that is exposed to the outside. An outer shape of the heat release member 21a is, for example, a plate-like fin. The plurality of heat release members 21a are in contact with the secondary side coil 15a.

The core member 22 includes, for example, a plate shape portion and a core portion that protrudes from the plate shape portion and is arranged in an empty core region of the secondary side coil 15a. The core member 22 is formed of, for example, a magnetic material such as an electromagnetic steel plate such as a silicon steel plate.

The back member 23 closes an opening end of a first accommodation portion A of the housing 21 that accommodates, for example, the secondary side coil 15a and the core member 22.

The cover member 24 closes an opening end of a second accommodation portion B of the housing 21 that accommodates, for example, the substrate 25 and the element 26.

The substrate 25 fixes, for example, a plurality of electronic components that constitute part of the electric power reception device 4.

The element 26 is, for example, a capacitor, a switching element, a rectifier element, and the like. The element 26 is mounted on the substrate 25.

The reception electric power conversion portion 16 shown in FIG. 1 and FIG. 2 is connected to the electric power conversion portion 13. The reception electric power conversion portion 16 includes a so-called full-bridgeless (or bridgeless and totem-pole) power factor correction (PFC) circuit that converts AC electric power into DC electric power. The so-called bridgeless PFC is a PFC that does not include a bridge rectifier using a plurality of diodes connected by bridge connection. The so-called totem-pole PFC is a PFC that includes a pair of switching elements having the same conductivity type connected (totem-pole connection) in series in the same direction.

The reception electric power conversion portion 16 includes: a third bridge circuit formed of, for example, a plurality of switching elements connected in two phases by bridge connection and a rectifier element; and a voltage-smoothing capacitor 16c. Each switching element is, for example, a transistor such as a SiC MOSFET. The plurality of switching elements are high-side arm and low-side arm transistors 16a, 16b that form a pair in each phase. The rectifier element is, for example, a reflux diode connected in parallel to each transistor 16a, 16b. The voltage-smoothing capacitor 16c is connected in parallel to the third bridge circuit.

For example, the electric power reception device 4 that includes the electric power reception portion 15 and the reception electric power conversion portion 16 receives electric power transmitted from the electric power transmission device 2 by controlling the switching between ON (conduction) and OFF (cutoff) of each switching element of the reception electric power conversion portion 16 in response to information of a frequency of electric power transmission by the electric power transmission device 2.

The control device 17 integrally controls, for example, the drive control device 3 and the electric power reception device 4 of the movable body such as a vehicle. The control device 17 is, for example, a software function unit that functions by a predetermined program being executed by a processor such as a CPU (Central Processing Unit). The software function unit is an ECU that includes the processor such as a CPU, a ROM (Read-Only Memory) that stores the program, a RAM (Random-Access Memory) that temporarily stores data, and an electronic circuit such as a timer. At least part of the control device 17 may be an integrated circuit such as a LSI (Large-Scale Integration).

For example, the control device 17 generates a control signal indicating a timing of driving each switching element to ON (conduction) and OFF (cutoff) and generates a gate signal for driving each switching element actually to ON and OFF on the basis of the control signal.

For example, by controlling the switching of each switching element of the electric power reception device 4, the control device 17 performs the power factor correction of the input voltage and the input current while rectifying AC electric power received from the electric power transmission device 2 to DC electric power.

For example, the control device 17 controls an output in accordance with a target output by a synchronous rectification operation that synchronously drives the plurality of switching elements of the electric power reception device 4 to ON and OFF and a short circuit operation that shorts the secondary side coil 15a.

For example, the control device 17 controls the synchronous rectification operation in accordance with the magnitude and the phase of a current generated in the electric power reception portion 15 by electric power transmitted from the electric power transmission device 2, that is, the current Ir flowing through the secondary side coil 15a. The control device 17 controls the plurality of switching elements of the reception electric power conversion portion 16 by soft switching of so-called zero voltage switching (ZVS). In the zero voltage switching (ZVS), in each switching element, a voltage of both ends is set to zero by the discharge of an output capacitance (parasitic capacitance) in an OFF state in a dead time period of each phase, and then, turn-on (switching from an OFF state to an ON state) is performed.

For example, the control device 17 controls the short circuit operation by turning on only the low-side arm of each phase while continuing the synchronous rectification operation of the zero voltage switching (ZVS) at the high-side arm of each phase of the reception electric power conversion portion 16.

For example, the control device 17 estimates the temperature of the secondary side coil 15a on the basis of a thermal model 20 of the coil unit 18.

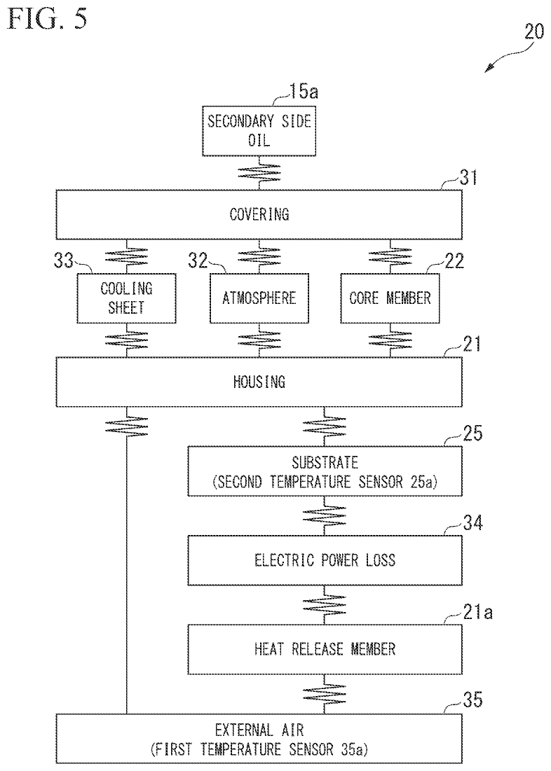

FIG. 5 is a view showing an example of a thermal model 20 of the coil unit 18 in the contactless electric power transmission system 1 of the embodiment.

As shown in FIG. 5, the thermal model 20 of the coil unit 18 is set, for example, with respect to a thermal gradient between the secondary side coil 15a and external air 35 in contact with the surface 21A of the housing 21. The thermal model 20 is constituted of, for example, a plurality of elements between the secondary side coil 15a and the external air 35 and a thermal resistance between adjacent elements.

For example, a wire of the secondary side coil 15a is connected to a covering 31 of the secondary side coil 15a via a thermal resistance. The covering 31 is connected to the core member 22, an atmosphere 32, and a cooling sheet 33 via respective thermal resistances. Each of the core member 22, the atmosphere 32, and the cooling sheet 33 is connected to the housing 21 via each thermal resistance. The housing 21 is connected to the substrate 25 and the external air 35 via respective thermal resistances. The substrate 25 is connected to an electric power loss 34 due to a switching loss and a conduction loss of the element 26 via a thermal resistance. The electric power loss 34 is connected to the heat release member 21a via a thermal resistance. The heat release member 21a is connected to the external air 35 via a thermal resistance.

For example, the control device 17 estimates, in the thermal model 20, a temperature of each element including the secondary side coil (wire) 15a on the basis of a detection value of a temperature output from each of a first temperature sensor 35a that detects the temperature of the external air 35 and a second temperature sensor 25a provided on the substrate 25, the thermal resistance between the elements, and a thermal capacity of each element.

For example, the control device 17 calculates a heat generation amount (heat reception amount) at each element due to a copper loss of the secondary side coil 15a, an iron loss of the core member 22, a loss of the element 26, and the like, and a heat extraction amount (heat release amount) at each element due to the external air 35 or the like depending on electric power at an operation point of the electric power reception device 4. The control device 17 estimates the temperature of each element on the basis of a temperature change obtained by the thermal capacity and the heat reception amount or the heat release amount at each element sequentially, for example, in accordance with the thermal gradient in thermal model 20.

For example, the control device 17 controls electric power (that is, an output of electric power transmission) received by the secondary side coil 15a from the electric power transmission device 2 in response to the temperature of each element in the thermal model 20.

The control device 17 calculates a frequency (request frequency) corresponding to electric power required for electric power transmission of the electric power transmission device 2, for example, on the basis of data of a correspondence relationship between the output and the frequency of electric power transmission indicating a different characteristic depending on the combination of a magnetic body, a coil, and the like in each of the electric power transmission portion 8 of the electric power transmission device 2 and the electric power reception portion 15 of the electric power reception device 4. The control device 17 transmits, to the electric power transmission device 2, the request frequency calculated at each timing before the movable body arrives at each electric power transmission zone of the electric power transmission device 2, for example, by an appropriate communication between the electric power transmission device 2 and the movable body. The communication between the electric power transmission device 2 and the movable body is, for example, a communication by an inductor voltage between the coils 8a, 15a of the electric power transmission device 2 and the electric power reception device 4, a communication by a current value detected by each current sensor of the electric power transmission portion 8 and the electric power reception portion 15, a wireless communication by a communication device additionally provided on each of the electric power transmission device 2 and the movable body, or the like.

Further, the control device 17 may regulate electric power received by the secondary side coil 15a from the electric power transmission device 2, for example, by performing a short circuit operation that short-circuits the secondary side coil 15a of the electric power reception device 4.

As described above, according to the contactless electric power transmission system 1 of the embodiment, by estimating the temperatures of a plurality of locations in the heat transfer path including at least the temperature of the secondary side coil 15a by using the thermal model 20 of the heat transfer path on the electric power reception side, the control device 17 can reliably perform an output control in the case of air cooling. The increase of the cooling requirement amount is prevented by the output control in accordance with the temperature of each element in the thermal model 20, and it is possible to ensure a desired cooling requirement amount by air cooling, for example, without the need to include an additional cooling device such as a liquid cooling device.

By estimating the temperature of the plurality of locations in the heat transfer path, for example, in a state in which a temperature increase is prevented or the like, it is possible to prevent excessive output restrictions from being performed and to reliably increase the output. For example, even when each state amount such as an inductance, a capacitance, and a resistance value and an eigenvalue (frequency) of the resonance circuit vary in response to each temperature characteristic of the plurality of elements, the magnetic member, and the like of the electric power reception portion 15, it is possible to perform a feedback to the request frequency of electric power transmission by the electric power transmission device 2, correction of the request frequency, or the like, and it is possible to prevent an output decrease and a loss increase of the electric power transmission caused by variation of the temperature at the electric power reception side.

For example, in the thermal model 20, by connecting the external air 35 and the housing 21 directly and via the heat release member 21a, the element 26, and the substrate 25 sequentially and connecting the housing 21 and the secondary side coil 15a via the core member 22, the control device 17 can accurately estimate at least the temperature of the secondary side coil 15a.

### Modification Example

Hereinafter, a modification example of the embodiment is described. The same portions as those of the embodiment described above are denoted by the same reference numerals, and descriptions thereof are omitted or simplified.

The above embodiment is described using an example in which the control device 17 estimates the temperatures of the plurality of locations in the heat transfer path at the electric power reception side on the basis of the thermal model 20; however, the embodiment is not limited thereto. For example, the control device 17 may estimate at least the temperature of the secondary side coil 15a by another thermal model by a combination of a plurality of elements different from the thermal model 20 and the outputs of the temperature sensors 35a, 25a.

The above embodiment is described using an example in which the contactless electric power transmission system 1 includes the storage electric power voltage conversion portion 12 that converts an input-output electric power of the electric power storage device 11; however, the embodiment is not limited thereto. The storage electric power voltage conversion portion 12 may be omitted.

For example, in the case of a hybrid vehicle or the like that is driven using the electric power storage device 11 and an internal combustion engine as a power source, the drive control device 3 may include the storage electric power voltage conversion portion 12. In the case of an electric automobile or the like that is driven using the electric power storage device 11 as a power source, the drive control device 3 may not include the storage electric power voltage conversion portion 12.

These embodiments of the present invention have been presented as examples and are not intended to limit the scope of the invention. These embodiments can be implemented in a variety of other modes, and various omissions, substitutions, and modifications can be made without departing from the scope of the invention. These embodiments and modifications thereof are included in the scope and gist of the invention and are also included in the scope of the invention described in the appended claims and equivalent thereof

What is claimed is:

1. A contactless electric power transmission system, comprising:
a coil unit which comprises
a housing having a surface that is exposed to an outside,
a coil that is arranged within the housing and receives AC electric power transmitted in a contactless manner from an electric power transmission device,
a magnetic member provided for the coil within the housing, and
a substrate on which an electronic component is mounted within the housing;
a first temperature sensor that detects a temperature of external air in contact with the surface of the housing;
a second temperature sensor that detects a temperature of the substrate; and
a control device that estimates at least a temperature of the coil based on a thermal model of the coil unit and a detection value of the temperature output from each of the first temperature sensor and the second temperature sensor and controls a request frequency of electric power transmission by the electric power transmission device and electric power which the coil receives from the electric power transmission device in response to the temperature of the coil.

2. The contactless electric power transmission system according to claim 1,
wherein in the thermal model, the control device connects the external air and the housing directly and via a heat release member, the electronic component, and the substrate sequentially and connects the housing and the coil via the magnetic member.
